(19) United States
(12) Patent Application Publication
(10) Pub. No.: US 2025/0131349 A1
(43) Pub. Date: Apr. 24, 2025

(54) METHOD FOR INTEGRATING A FIELD DEVICE INTO AN OPERATING SYSTEM OF AN AUTOMATION SYSTEM

(71) Applicant: Endress+Hauser Conducta GmbH+Co. KG, Gerlingen (DE)

(72) Inventors: Björn Haase, Stuttgart (DE); Thomas Alber, Stuttgart (DE); Oliver Durm, Benningen am Neckar (DE); Roman Griesser, Gerlingen (DE); Martin Lohmann, Gerlingen (DE); Stefan Robl, Hünxe (DE); Karsten Traub, Bietigheim-Bissingen (DE)

(21) Appl. No.: 18/917,178

(22) Filed: Oct. 16, 2024

(30) Foreign Application Priority Data
Oct. 18, 2023 (DE) 10 2023 128 597.1

(51) Int. Cl. G06Q 10/0631; G06F 21/33; H04L 9/08; H04L 9/32

(52) U.S. Cl. CPC G06Q 10/06311; G06F 21/335; H04L 9/0825; H04L 9/3213; G06Q 2220/00

(57) ABSTRACT

A method for integrating a field device into an operating system is provided. The operating system includes a ticket server communicating with a transport medium. The ticket server and existing field devices process tickets, which contain a cryptographically secured item of information and transmit the created tickets to the transport medium, where the transport medium transmits the tickets to the recipient(s) and the recipient(s) check(s) the authenticity and integrity of the tickets. The method includes placing an order for the field device and generating registration data by a manufacturer's server. The registration data comprise identification information of the field device and a first cryptographically relevant item of information. The method also includes registering the field device as an existing field device on the ticket server. The registration data are transmitted to the ticket server and a second cryptographically relevant information of the ticket server is stored in the field device.

### CROSS-REFERENCE TO RELATED APPLICATION

The present application is related to and claims the priority benefit of German Patent Application No. 10 2023 128 597.1, filed on Oct. 18, 2023, the entire contents of which are incorporated herein by reference.

### TECHNICAL FIELD

The present disclosure relates to a method for integrating a field device into an operating system of an automation system, wherein the operating system comprises at least one transport medium and a ticket server communicating with the transport medium, wherein the ticket server and the field devices are designed to create and/or process tickets, which in each case contain at least one cryptographically secured item of information and in which in each case one or more recipients from the group of ticket server and field devices are defined, wherein the ticket server and the field devices are designed to transmit the created tickets to the transport medium, wherein the transport medium transmits the tickets to the recipient(s), and wherein the recipient(s) check(s) the authenticity and integrity of the tickets.

### BACKGROUND

Field devices that are used in industrial installations are already known from the prior art. Field devices are often used in process automation engineering, as well as in manufacturing automation engineering. In principle, all devices which are process-oriented and which supply or process process-relevant information are referred to as field devices. Field devices are thus used for detecting and/or influencing process variables. Measuring devices, or sensors, are used for detecting process variables. These are used, for example, for pressure and temperature measurement, conductivity measurement, flow measurement, pH measurement, fill level measurement etc., and detect the corresponding process variables of pressure, temperature, conductivity, pH value, fill level, flow etc. Actuators are used for influencing process variables. These are, for example, pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level.

A multitude of such field devices is produced and marketed by the Endress+Hauser group.

In modern industrial plants, field devices are usually connected to superordinate units via communication networks such as fieldbuses (Profibus®, Foundation® Fieldbus, HART® etc.). Usually, the superordinate units are control systems (DCS) or control units, such as an SPC (stored program control). The superordinate units are used for, among other things, process control, process visualization, and process monitoring, as well as commissioning of the field devices. The measured values detected by the field devices, such as by sensors, are transmitted via the respective bus system to an (or in some cases a plurality of) superordinate unit(s). In addition, data transmission from the superordinate unit via the bus system to the field devices is also required, such as for configuration and parameterization of field devices and for controlling actuators.

Mobile control units can also be used to operate field devices that have implemented an FDT frame application. For example, there are control units that are connected to the fieldbus network. However, the control unit can also communicate with the field devices via a wireless communications connection, in particular based upon a Bluetooth standard. The applicant produces and sells devices which, as so-called Bluetooth gateways, allow the control units to be coupled to the field devices. The field device is connected to a Bluetooth gateway via wires, in particular using the HART or CDI communication standards. Alternatively, the field devices themselves have their own Bluetooth interfaces.

If a mobile device, such as a smartphone or tablet, is used as a control unit for wireless communication with the field devices, application programs, so-called apps, are available which make the operating functions for the field device available to the mobile device.

In industrial environments, most of the installed field devices have no or only very basic protection against unauthorized access. In these field devices, all device parameters can usually be accessed directly or, for example, after entering an unlock code. As a result of the Federal Security Act [Bundessicherheitsgesetz] in Germany, more and more field devices are coming onto the market that have individual user accounts and role-based authorization. For access via a user interface or machine interface, an, in a certain sense “permanent,” authorization is required, which is usually granted by prior authentication. The authorization must be chosen in such a way that the access user has (permanently) all the authorizations they need to carry out their tasks. Standards such as IEC 62443-4-2 describe how to implement a state-of-the-art authentication mechanism.

Due to the resulting immense administrative effort for the login data of the field devices, technologies for central user administration are emerging, as has been common practice in the IT sector for years with regard to IT devices (for example, printers, workstations, etc.). An example of such a concept is disclosed in DE 10 2018 1026 08 A1, in which a transport medium is provided to which user data are transferred from a user database, wherein after checking the user data, access to the field device is granted.

There are also ideas for limiting the access permissions required by people to a minimum. DE 102019131860 A1, for example, discloses providing a digital order ticket which is transmitted from a server to the mobile device, which order ticket contains the access rights and the authorized tasks for the field device. This order ticket is transmitted when the connection is established with the field device. If authorization is available, the tasks contained in the order ticket, such as parameterization actions or execution of functional tests, can be processed with the field device.

Field devices that can be managed with such operating systems must be connected to the units to be managed (user management system in the form of a ticket server) after delivery to the customer. This usually happens through a key exchange between the field device and the managing unit, which must be carried out manually by the customer. With a large number of field devices, this involves a personnel and cost expenditure that should not be underestimated.

### SUMMARY

Based upon this problem, the object of the present disclosure is to connect field devices in a simple manner to a control system with user management.

The object is achieved by a method for integrating a field device into an operating system of an automation system, wherein the operating system comprises at least one transport medium and a ticket server communicating with the transport medium, wherein the ticket server and the field devices are designed to create and/or process tickets, which in each case contain at least one cryptographically secured item of information and in which in each case one or more recipients from the group of ticket server and field devices are defined, wherein the ticket server and the field devices are designed to transmit the created tickets to the transport medium, wherein the transport medium transmits the tickets to the recipient(s), and wherein the recipient(s) check(s) the authenticity and integrity of the tickets, comprising the placing of an order for the field device by the customer, and generating registration data for the field device by a manufacturer's server on the basis of the order. The registration data comprise identification information of the field device and a first cryptographically relevant item of information. The method also includes registering the field device as an existing field device on the ticket server, wherein in the course of registration the registration data are transmitted to the ticket server and a second cryptographically relevant item of information of the ticket server is stored in the field device.

The core of the method according to the present disclosure is to provide a mechanism to connect a field device to a ticket server already at production time. Thus, upon delivery to the customer the field device will already be registered on the ticket server. The customer can then start managing the new field device directly via the ticket server in his installation system.

A ticket is a digital, tamperproof data packet that, in addition to a signature (or an authenticity verification code) of the unit issuing the ticket, in this case, the ticket server or the field device, contains additional data. The additional data, for example, if the transport medium is an operating unit, are an authorization for the operating unit to carry out defined tasks on the field device. In addition to the authorization for this task, the ticket can also contain, for example, a valid value range for the field device parameters to be written. By means of the signature, the recipient of the ticket is enabled to check the authenticity and integrity of the ticket. For this verification, the field device needs the first cryptographically relevant item of information of the ticket server. If the ticket is created by the field device, the ticket server can carry out the verification with the aid of the second cryptographically relevant item of information of the ticket server.

The cryptographically relevant information comprises, for example, public keys of a key pair (where the key pair consists of a private key, which is written into the field device in the case of the first cryptographically relevant item of information, or remains on the ticket server in the case of the second cryptographically relevant item of information, and the corresponding public key). Alternatively, it is information that is required for so-called “challenges” by means of which the field device and the ticket server establish a trust relationship.

Examples of field devices that are mentioned within the scope of the method according to the present disclosure have already been listed as examples in the introductory part of the description.

An existing field device is a field device that has been put into operation by the customer as intended and that processes the tasks defined within the scope of its intended application (e.g. detecting and/or influencing measured variables of a process engineering operation).

An advantageous embodiment of the method provides that a registration module is assigned to the ticket server, wherein the registration data are transferred from the manufacturer's server to the registration module, wherein the second cryptographically relevant item of information is transferred from the registration module to the manufacturer's server, and wherein the registration module registers the field device as an existing field device on the ticket server. In particular, it is provided that the registration data are transferred to the registration module in the form of a first exchange ticket, which is created by the manufacturer's server, and wherein the second cryptographically relevant item of information is transferred to the manufacturer's server in the form of a second exchange ticket, which is created by the registration module or by the ticket server.

An exchange ticket is a ticket as defined above. The registration data can be found in particular as “additional data” in the first exchange ticket. The second cryptographically relevant item of information is located in particular as “additional data” in the second exchange ticket. In particular, it is provided that cryptographically relevant information for mutually verifying the authenticity and integrity of the exchange tickets has been exchanged in advance between the ticket server, or registration module, and the manufacturer's server.

According to one embodiment of the method, it is provided that a software module or a hardware module is used as the registration module. In the event that the ticket server is a local server that is located within the system or is located close to the system and is connected to the system network via a local network connection, the registration module can be designed as a hardware module. In the event that the ticket server is a cloud-based server and can be contacted via the internet, the registration module can be designed as a software module.

A first variant of the method provides that a digital image of the field device is generated in the course of ordering, wherein the registration data are transferred from the manufacturer's server to the digital image of the field device, wherein the second cryptographically relevant item of information is transferred from the registration module to the digital image of the field device, wherein in the course of registration the registration data are transferred from the digital image of the field device to the registration module. A digital image is a virtual representation of a field device that has the same properties as the real field device. For example, the digital image is assigned the same configurations and parameter settings as the real field device. For example, after completion of production of the field device, or at any other point in time when the physical field device exists, the field device must be synchronized with its digital image, so that the second cryptographically relevant item of information is written into the field device.

According to a second variant of the method, it is provided that the manufacturer's server and the registration module are in communication connection, wherein the registration data are transferred from the manufacturer's server to the registration module via the communication connection, and wherein the second cryptographically relevant item of information is transferred from the registration module to the manufacturer's server via the communication connection. This second cryptographically relevant item of information is then written into the field device during production or after production has been completed.

According to an embodiment of the second variant of the method, it is provided that the manufacturer's server accesses the registration module via a REST API of the registration module for the purpose of mutual data or information transfer. A REST API (also known as a RESTful API) is an architectural style for an application programming interface (API) that defines access to data and/or information and use of data and/or information. It is used for mutual communication between different instances.

According to a third variant of the method, it is provided that the manufacturer's server and the registration module are not in communication connection.

According to an embodiment of the third variant of the method, it is provided that the registration data are entered into the registration module by a user via a graphical user interface. For example, the registration data are generated by the manufacturer server as code (e.g. hex code or BASE32 or BASE64) and can be output to the user as a (human-readable) character string (a so-called “string”), which is entered by the user into the registration module. In particular, the registration module in this variant is designed as a software module. Alternatively, the user accesses a web server of the registration module, which is designed as a hardware module, by means of a computing unit.

According to an alternative embodiment of the third variant of the method, it is provided that the registration data or the first exchange ticket containing the registration data are present as an optically detectable code, in particular as a barcode or as a QR code, wherein an optical detection unit is assigned to the registration module, and wherein the registration module reads the code via an optical detection unit. For this purpose, the registration module can be designed as a (portable) hardware module, which comprises the optical detection unit. Alternatively, an operating unit, for example a mobile device, can be used, which comprises the optical detection unit and which is in communication connection with the registration module (which can be designed as a hardware or software module).

The optical detection unit is, for example, a photodiode or a camera.

The code can be transferred to the user as a paper printout. Alternatively, the optically detectable code can be located on the manufactured field device, for example on the type plate or for example as a sticker on the housing of the field device.

According to a further alternative embodiment of the third variant of the method, it is provided that the first exchange ticket is transferred from the manufacturer's server to a data carrier and whereby the first exchange ticket is transferred from the data carrier to the registration module. The data storage device, for example a USB stick or an SD card, is passed to the customer by the manufacturer of the field device, for example as part of the delivery of the field device.

With regard to the second cryptographically relevant item of information originating from the ticket server, it is then provided that the second cryptographically relevant item of information is communicated to the manufacturer's server in the course of the placing of the order by the user, in particular by a user input or by transfer of a file containing the second cryptographically relevant item of information.

After registration of the field device on the ticket server, it can now be provided that an operating unit is provided as a transport medium for operating existing field devices located in the installations, wherein the tickets contain data that authorize the operating unit to carry out a defined work order on a defined existing field device. The field device verifies the ticket for authenticity and integrity (by means of the second cryptographically relevant item of information) and releases the corresponding operating functions for the operating unit.

Alternatively, the storage medium can be used as the transport medium. In this case, for example, an activation of the corresponding operating functions is effected on an operating unit of the field device, e.g. a touch display.

After execution of the work order, the field device can send a confirmation ticket back to the ticket server, likewise using the transport medium.

According to a method of the present disclosure, the operating unit authenticates itself to the existing field devices defined in the corresponding order tickets. This is particularly useful if the order ticket and the associated tasks are tied to a specific operating unit. Authentication means that the operating unit must prove its identity to the field device after the ticket has been transferred, for example by transmitting an (unchangeable) identification to the field device or by adding its own signature to the order ticket. Such machine-to-machine authentication typically uses one of the following methods:
1.: The operating unit claims to be the owner of a specific key pair, whereby the public key of the key pair is transferred. Using a challenge-response method, the operating unit must prove to the field device that it is in possession of the associated private key of the key pair
2.: The operating unit sends the field device a signed message with its identification. The field device verifies the signature and if this is OK, will believe that the stated identity is correct.
3.: Similar to 2., but the message is encrypted with the identity of the control unit. The field device decrypts the message and then trusts the content.

In cases 2, and 3., trust is based on a signature or an encryption. These methods usually use a so-called pre-shared key (PSK), i.e. a key that must be known to both participants before communication.

### BRIEF DESCRIPTION OF THE DRAWINGS

The present disclosure is explained in greater detail with reference to the following figures. The following is shown:

FIG. 1 shows a first exemplary embodiment of the method according to the present disclosure;

FIG. 2 shows a second exemplary embodiment of the method according to the present disclosure; and

FIG. 3 shows a third exemplary embodiment of the method according to the present disclosure.

### DETAILED DESCRIPTION

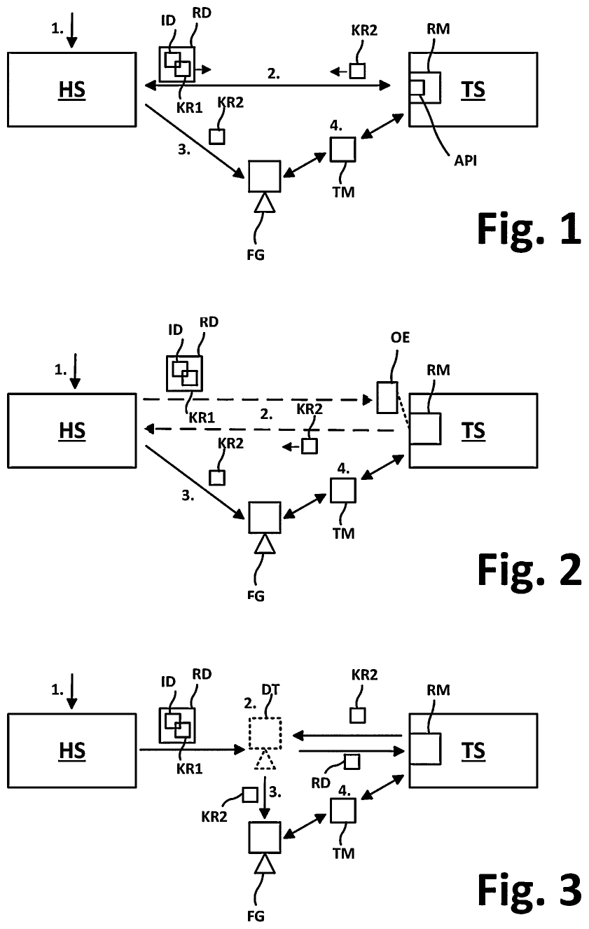

FIG. 1 shows a first exemplary embodiment. In a first step 1., an order from the customer is received by a manufacturer's server HS of the field device manufacturer. In the course of placing the order, the customer enters the exact details of the field device FG to be ordered into the manufacturer's server HS, along with an identification of the ticket server TS, which is used to operate the existing field devices of the customer. After verification of the order data of the customer (for example, whether the ticket server TS specified by the customer in the course of the order actually belongs to the customer), the order is created.

The manufacturer's server then creates registration data RD relating to the ordered field device FG. The registration data consist of an item of identification information ID of the field device FG, for example a serial number, and a first cryptographically relevant item of information KR1.

In a second step 2., a communication connection is established between the manufacturer's server HS and the ticket server TS of the customer, in particular via the internet. The manufacturer's server HS transmits the registration data RD to the ticket server TS via the communication connection. In addition, the ticket server TS transmits a second cryptographically relevant item of information KR2 via the communication connection to the manufacturer's server. The cryptographically relevant information KR1, KR2, for example, comprise public keys of a key pair.

The registration data RD and the second cryptographically relevant item of information KR2 are transmitted in the form of so-called order tickets. An order ticket is a ticket, i.e. a digital, tamperproof data packet that, in addition to a signature of the unit issuing the ticket, in this case, the ticket server TS or the manufacturer's server HS, contains additional data. The other data are the registration data RD or the second cryptographically relevant item of information KR2. By means of previously exchanged information, e.g. public keys, the ticket server TS and the manufacturer's server HS can verify the respective order tickets for integrity and authenticity and only process their contents if the verification is successful.

The communication between the ticket server TS and the manufacturer's server HS is effected via a REST API of the registration module RD. After successful verification, the registration module RD processes the registration data RD and stores the first cryptographically relevant item of information KR1 under the identification information ID of the field device FG on the ticket server TS. It can also be provided that the data exchange between the ticket server TS and the manufacturer's server HS is effected via the registration module.

In step 3., the field device FG is produced. During production or after completion of production, the second cryptographically relevant item of information KR2 is written into the field device FG. In the event that the cryptographically relevant information is a public key, the private key corresponding to the first cryptographically relevant item of information KR1, which was transmitted to the ticket server TS, is also written into the field device FG.

In step 4., the field device FG is delivered to the customer and installed in the measuring station of his installation. By exchanging the cryptographically relevant information KR1, KR2, the field device FG and the ticket server TS have already become known to one another. The field device FG can be operated via a transport medium TM. For this purpose, the ticket server TS transmits a ticket to the field device FG. In this case, the transport medium TM is an operating unit, in particular a laptop or a mobile device in the form of a smartphone or a tablet. Alternatively, the transport medium can also be a storage medium. The term “transport medium” can also be understood as a network via which a ticket is transmitted directly from the ticket server TS to the field device FG.

In this case, the control unit is connected as a transport medium TM to the ticket server TS via a mobile network or via a local network. The connection between the control unit and the field device FG is effected, for example, wirelessly via a Bluetooth connection or wired (e.g. via CDI protocol). A ticket issued by the ticket server TS contains, in the event that the field device FG is to be operated, data that authorize the operating unit to carry out a defined work order on a defined existing field device. Here, the ticket is signed by means of the private key of the key pair. The field device FG verifies the ticket for authenticity and integrity (by means of the second cryptographically relevant item of information KR2, in this case the public key of the key pair) and releases the corresponding operating functions for the operating unit. The field device FG confirms that the operating action has been carried out by issuing a ticket, which is transferred back to the ticket server TS via the transport medium. The ticket server can verify the integrity and authenticity of this ticket by means of the first cryptographically relevant item of information.

A second exemplary embodiment of the method is shown in FIG. 2. The method is largely similar to that described with reference to FIG. 1. In particular, method steps 1., 3. and 4. correspond to those of the method in FIG. 1. The exemplary embodiment differs in step 2. from the method described with reference to FIG. 1.

The manufacturer's server HS and the ticket server TS are unable to establish a communication connection with one another. The transmission of the registration data or RD, the first exchange ticket containing the registration data RD, from the manufacturer's server HS or the registration module RM, to the ticket server TS is effected in the form of an optically detectable code, in particular a barcode or as a QR code. For this purpose, an optical detection unit OE is assigned to the registration module RM of the ticket server TS, by means of which the optical code can be read.

The optical detection unit EE can be designed as a (portable) hardware module, which is the registration module RM. Alternatively, an operating unit, for example a mobile device, can be used, which comprises the optical detection unit OE and which is in communication connection with the registration module RM. The optical detection unit OE is, for example, a photodiode or a camera.

The code can be transferred to the user as a paper printout. Alternatively, the optically detectable code can be located on the manufactured field device FG, for example on the type plate or for example as a sticker on the housing of the field device.

The second cryptographically relevant item of information KR2, which comes from the ticket server, is transferred by the user to the manufacturer's server. This can be effected by user input or by transferring a file containing the second cryptographically relevant item of information KR2.

A third exemplary embodiment of the method is shown in FIG. 3. The method is largely similar to that described with reference to FIG. 1. In particular, method steps 1. and 4. correspond to those of the method in FIG. 1. This exemplary embodiment differs in steps 2. and 3. from the method described with reference to FIG. 1.

Here too, the manufacturer's server HS and the ticket server TS are unable to establish a communication connection with one another. In the course of the ordering of the field device FG, a digital image DT is created for this field device FG. A digital image (also called a “digital twin”) is a virtual representation of a field device that has the same properties as the real field device FG. For example, the digital image DT is assigned the same configurations and parameter settings as the real field device FG.

In the second step 2. the manufacturer's server HS transmits the registration data RD to the digital image DT of the field device FG. Furthermore, the ticket server TS, or the registration module RM, transmits a second cryptographically relevant item of information KR2 to the digital image FT of the field device FG.

In step 3., for example after completion of the production of the field device FG or at another point in time when the field device FG already physically exists, the field device FG will be synchronized with its digital image DT in order to write the second cryptographically relevant item of information KR 2 into the field device FG.

The method according to the present disclosure makes it possible to provide a mechanism to connect a field device FG to the ticket server TS already at production time. The field device FG is thus already registered on the ticket server upon delivery to the customer. The customer can then start managing the new field device FG directly via the ticket server in his installation system.

1. A method for integrating a field device into an operating system of an automation system, wherein the operating system comprises at least one transport medium and a ticket server communicating with the transport medium, wherein the ticket server and existing field devices located in the system are designed to create and/or process tickets, which tickets in each case contains at least one cryptographically secured item of information and in which in each case one or more recipients from the group of the ticket server and the existing field devices are defined, wherein the ticket server and the existing field devices are designed to transmit the created tickets to the transport medium, wherein the transport medium transmits the tickets to the recipient(s), and wherein the recipient(s) check(s) the authenticity and integrity of the tickets, comprising:
placing an order for the field device by a customer;
generating registration data for the field device on the basis of the order by a manufacturer's server, wherein the registration data comprise identification information of the field device and a first cryptographically relevant item of information; and
registering the field device as an existing field device on the ticket server, wherein in the course of registration the registration data are transmitted to the ticket server and a second cryptographically relevant item of information of the ticket server is stored in the field device.

2. The method according to claim 1, wherein the ticket server is assigned a registration module, wherein the registration data are transferred from the manufacturer's server to the registration module, wherein the second cryptographically relevant item of information is transferred from the registration module to the manufacturer's server, and wherein the registration module registers the field device as an existing field device on the ticket server.

3. The method according to claim 2, wherein the registration data are transferred to the registration module in the form of a first exchange ticket, which is created by the manufacturer's server, and wherein the second cryptographically relevant item of information is transferred to the manufacturer's server in the form of a second exchange ticket, which is created by the registration module or the ticket server.

4. The method according to claim 3, wherein a software module or a hardware module is used as the registration module.

5. The method according to claim 2, wherein a digital image of the field device is generated in the course of ordering, wherein the registration data are transferred from the manufacturer's server to the digital image of the field device, wherein the second cryptographically relevant item of information is transferred from the registration module to the digital image of the field device, wherein in the course of registration the registration data are transferred from the digital image of the field device to the registration module.

6. The method according to claim 2, wherein the manufacturer's server and the registration module are in communication connection, wherein the registration data are transferred from the manufacturer's server via the communication connection to the registration module, and wherein the second cryptographically relevant item of information is transferred from the registration module to the manufacturer's server via the communication connection.

7. The method according to claim 6, wherein the manufacturer's server accesses the registration module via a REST API of the registration module for the purpose of mutual data or information transfer.

8. The method according to claim 2, wherein the manufacturer's server and the registration module are not in communication connection.

9. The method according to claim 8, wherein the registration data are entered into the registration module by a user via a graphical user interface.

10. The method according to claim 8, wherein the registration data or the first exchange ticket containing the registration data are present as an optically detectable code, in particular as a barcode or as a QR code, wherein an optical detection unit is assigned to the registration module, and wherein the registration module reads the code via an optical detection unit.

11. The method according to claim 4, wherein the first exchange ticket is transferred from the manufacturer's server to a data carrier and wherein the first exchange ticket is transferred from the data carrier to the registration module.

12. The method according to claim 8, wherein the second cryptographically relevant item of information is communicated to the manufacturer's server in the course of the placing of the order by the user.

13. The method according to claim 1, wherein an operating unit for operating existing field devices located in the installations is provided as a transport medium, wherein the tickets contain data that authorize the operating unit to carry out a defined work order on a defined existing field device.

14. The method according to claim 1, wherein the operating unit authenticates itself to the existing field devices defined in the corresponding tickets.
